(19) United States
(12) Patent Application Publication
(10) Pub. No.: US 2025/0371858 A1
(43) Pub. Date: Dec. 4, 2025

(54) GENERATING SPATIAL-TEMPORAL FEATURES FOR VIDEO PROCESSING APPLICATIONS

(71) Applicant: Digital Surgery Limited, London (GB)

(72) Inventors: Felix John Samuel Bragman, London (GB); Danail V. Stoyanov, London (GB); Imanol LuengoMuntion, Bilbao (ES)

(21) Appl. No.: 19/219,483

(22) Filed: May 27, 2025

Related U.S. Application Data
(60) Provisional application No. 63/655,215, filed on Jun. 3, 2024.

(51) Int. Cl. G06V 10/82; G06V 10/62; G06V 20/40; G06V 20/50

(52) U.S. Cl. CPC G06V 10/82; G06V 20/40; G06V 20/50; G06V 10/62; G06V 2201/03

(57) ABSTRACT

Examples described herein provide a computer-implemented method that includes generating temporal prompts based on a video frame history. The method further includes generating, using a mixture of experts (MoE) transformer encoder, the frame prediction for the frame of the video of the surgical procedure based on the frame of the video of the surgical procedure and the temporal prompts.

### CROSS REFERENCE TO RELATED APPLICATION

The present application claims the benefit of U.S. Provisional Patent Application Ser. No. 63/655,215, filed on Jun. 3, 2024, the entire content of which is incorporated herein by reference.

### BACKGROUND

The present disclosure relates in general to computing technology and relates more particularly to computing technology for generating spatial-temporal features for video processing applications.

Computer-assisted systems, particularly computer-assisted surgery systems (CASs), rely on video data digitally captured during a surgery. Such video data can be stored and/or streamed. In some cases, the video data can be used to augment a person's physical sensing, perception, and reaction capabilities. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes such as archival, training, post-surgery analysis, and/or patient consultation.

### SUMMARY

According to an aspect, a computer-implemented method for generating a frame prediction for a frame of a video of a surgical procedure is provided. The method includes generating temporal prompts based on a video frame history. The method further includes generating, using a mixture of experts (MoE) transformer encoder, the frame prediction for the frame of the video of the surgical procedure based on the frame of the video of the surgical procedure and the temporal prompts.

According to another aspect, a system is provided. The system includes a data store comprising video data comprising a sequence of a plurality of image frames associated with a surgical procedure. The system further includes a machine learning execution system comprising a spatial-temporal modular network (STMN) model comprising a prompt predictor network and a mixture of experts (MoE) transformer encoder. The STMN model is configured to generate, using the prompt predictor network, temporal prompts based on a video frame history. The STMN model is further configured to generate, using the MoE transformer encoder, a frame prediction for one of the plurality of image frames of the video data of the surgical procedure based on one of the plurality of image frames and the temporal prompts.

According to yet another aspect, a computer program product for anatomy detection using surgical phase information is provided. The computer program product includes a set of one or more computer-readable storage media and program instructions, collectively stored in the set of one or more storage media, for causing a processor set to perform operations for generating a frame prediction for a frame of a video of a surgical procedure. The operations include generating temporal prompts based on a video frame history, the temporal prompts expressed as a vector of temporal prompts that parameterize the video frame history and contain informative temporal context. The operations further include generating, using a mixture of experts (MoE) transformer encoder, the frame prediction for the frame of the video of the surgical procedure based on the frame of the video of the surgical procedure and the temporal prompts, wherein generating the frame prediction further comprises processing the frame of the video of the surgical procedure and the temporal prompts using concatenation.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the aspects described herein are apparent from the following detailed description taken in conjunction with the accompanying drawings in which:

FIG. 1 depicts a computer-assisted surgery (CAS) system according to one or more aspects described herein;

FIG. 2 depicts a surgical procedure system according to one or more aspects described herein;

FIG. 3 depicts a system for analyzing video captured by a video recording system according to one or more aspects described herein;

FIG. 4 depicts a spatial-temporal modular network (STMN) according to one or more aspects described herein;

FIGS. 5A-5D depict MoE history routing for the STMN of FIG. 4 according to one or more aspects;

FIGS. 6A and 6B depict mixture of experts prompt routing for the STMN of FIG. 4 according to one or more aspects;

FIGS. 7A-7C depict aspects of adaptive control with batch priority routing for the STMN of FIG. 4 according to one or more aspects;

FIG. 8 depicts a flow diagram of a method for generating a frame prediction for a frame of a video of a surgical procedure according to one or more aspects described herein; and

FIG. 9 depicts a block diagram of a computer system according to one or more aspects described herein.

The diagrams depicted herein are illustrative. There can be many variations to the diagrams and/or the operations described herein without departing from the scope of the aspects. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Computer vision applications applied to videos, such as object tracking and instance segmentation, often utilize temporal networks. Such approaches are computationally expensive and, as such, are not suitable for real-time use.

One or more aspects described herein provide for generating spatial-temporal features (e.g., a frame prediction) for computer vision applications. According to one or more aspects, a temporal model is provided that uses mixture of experts (MoE) for explicit control of the computational resources at deployment. As used herein, “mixture of experts” refers to a machine learning technique that uses multiple expert neural networks (or “learners”) to divide a problem space into homogenous regions. According to one or more aspects, the spatial-temporal features (e.g., frame predictions) are generated for online and offline models that are used to perform computer vision applications. Non-limiting examples of such computer vision applications include surgical phase annotation, surgical instrument detection and tracking, anatomy localization and segmentation, and/or the like, including combinations and/or multiples thereof.

According to one or more embodiments, the MoE model also gives the ability to increase parameter capacity without affecting the computational cost at inference. For example, if k=1, where k is the number of experts in the MoE model (e.g., one expert is activated per patch), there is no difference with a transformer with no MoE layer, just a conventional MLP layer. According to one or more embodiments, the MoE provides the ability to learn more flexible temporal representations, which can improve prediction quality.

According to one or more aspects, a spatial-temporal modular network (STMN) is provided. MoEs are used with a noisy top-k routing network where k=1 to increase parameter capacity with no penalties in terms of floating point operations per second (FLOPs). To dynamically control the processing resources, a batch priority routing approach is provided that reduces or eliminates redundant temporal patches and least informative areas of a current frame.

One or more of the models described herein can modulate an amount of computation (e.g., in terms of FLOPs) required to free up resources to run models simultaneously when deployed on relatively low powered processing systems and/or to speed up processing of post-operative videos to save computing resources typically associated with cloud-based processing, such as graphical processing unit resources. As used herein, relatively low powered processing systems are processing systems with fewer resources (e.g., memory resources, computational/processing resources, graphics processing unit (GPU) resources, and/or the like, including combinations and/or multiples thereof) as compared to systems that typically run deployed models for performing computer vision applications.

The STMN model described herein was tested on laparoscopic cholecystectomy procedures and compared to a Swin) transformer with a segmentation head on a single frame (no sliding window but processed on each consecutive frame in a video independently) and a spatial-temporal prompting network (STPN) on cystic artery and cystic duct segmentation. The STMN model in accordance with aspects described herein improved cystic artery and duct performance by substantially 1.40% and substantially 4.37% respectively compared to the Swin transformer approach and improved STPN performance by substantially 0.97% and substantially 2.27% respectively. Eliminating substantially 40% of tokens resulted in only a substantially 10% reduction in performance, thus representing a large improvement in efficiency of computing resources.

One or more aspects described herein address the shortcomings of the prior art by providing a model that incorporates a MoE transformer encoder architecture with temporal conditioned mixture of experts to improve performance in video-based tasks and enable adaptive control of the amount of information processed in real-time. The use of the MoE transformer encoder architecture provides for applying a sorting algorithm on temporal batches of tokens to control the capacity of the temporal network. One or more aspects provides a batch priority routing approach that uses a batch priority routing algorithm based on a temporal batch of tokens rather than on a single frame. This approach proposes to seek out temporal redundancy of frames and those uninformative in the current frame. Since the MoE transformer encoder architecture provided herein uses temporal conditioned routing, when the temporal-based batch priority routing algorithm is applied on a current frame, the sparsification of the input is temporarily aware and sorting is performed based on temporal and current context. This approach differs from convention batch priority routing, which only considers the current frame context.

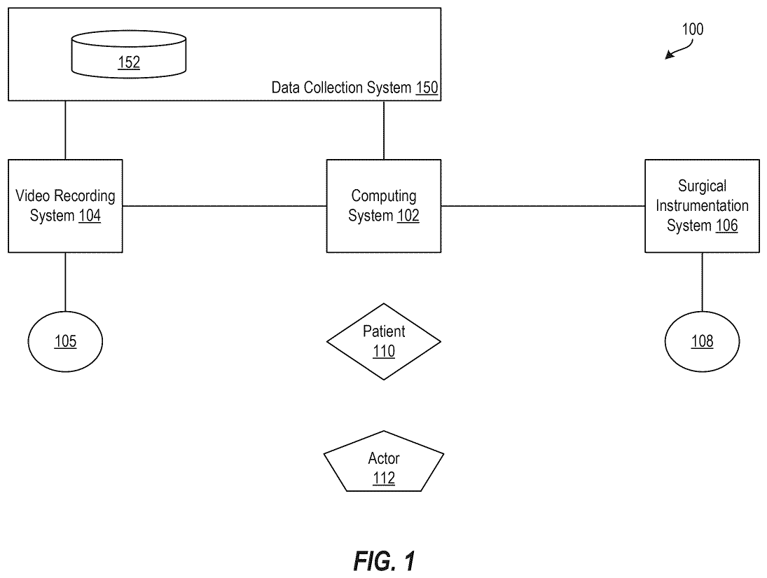

Turning now to FIG. 1, an example computer-assisted system (CAS) system 100 is generally shown in accordance with one or more aspects. The CAS system 100 includes at least a computing system 102, a video recording system 104, and a surgical instrumentation system 106. As illustrated in FIG. 1, an actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, and/or the like including combinations and/or multiples thereof.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. In addition, a particular anatomical structure of the patient may be the target of the surgical action(s).

The video recording system 104 includes one or more cameras 105, such as operating room cameras, endoscopic cameras, and/or the like including combinations and/or multiples thereof. The cameras 105 capture video data of the surgical procedure being performed. The video recording system 104 includes one or more video capture devices that can include cameras 105 placed in the surgical room to capture events surrounding (i.e., outside) the patient being operated upon. The video recording system 104 further includes cameras 105 that are passed inside (e.g., endoscopic cameras) the patient 110 to capture endoscopic data. The endoscopic data provides video and images of the surgical procedure.

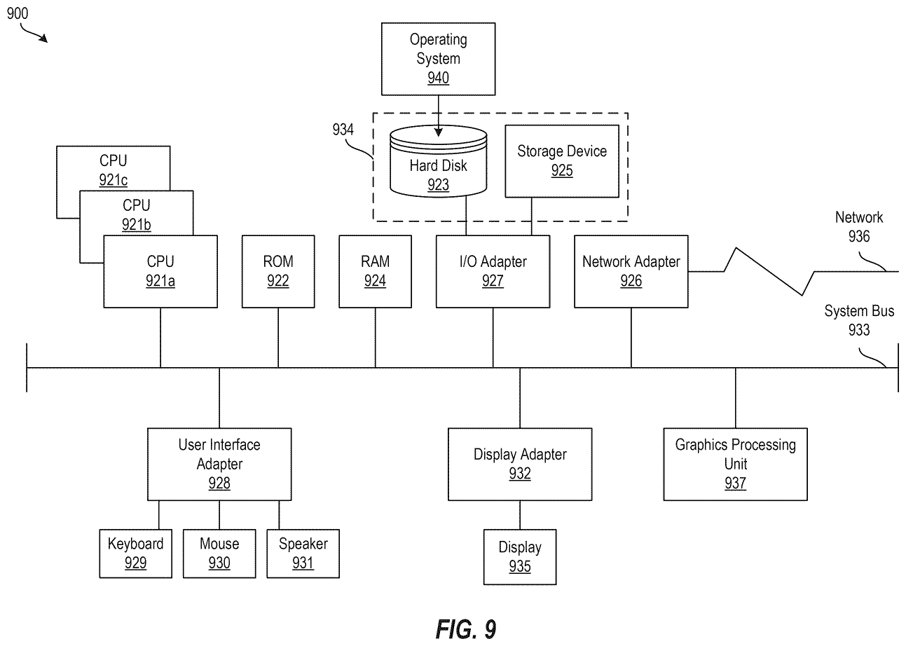

The computing system 102 includes one or more memory devices, one or more processors, a user interface device, among other components. All or a portion of the computing system 102 shown in FIG. 1 can be implemented for example, by all or a portion of computer system 900 of FIG. 9. Computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures, such as anatomical structures, surgical instruments 108 in the captured video of the surgical procedure. Features can further include events, such as phases and/or actions in the surgical procedure. Features that are detected can further include the actor 112 and/or patient 110. Based on the detection, the computing system 102, in one or more examples, can provide recommendations for subsequent actions to be taken by the actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models use a combination of video data and surgical instrumentation data.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the various types of data captured during the surgical procedure, in an offline manner (e.g., post-surgery). In one or more examples, the machine learning models detect surgical phases based on detecting some of the features, such as the anatomical structure, surgical instruments, and/or the like including combinations and/or multiples thereof.

A data collection system 150 can be employed to store the surgical data, including the video(s) captured during the surgical procedures. The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, and/or the like including combinations and/or multiples thereof. In some examples, the data collection system can use a distributed storage, i.e., the storage devices 152 are located at different geographic locations. The storage devices 152 can include any type of electronic data storage media used for recording machine-readable data, such as semiconductor-based, magnetic-based, optical-based storage media, and/or the like including combinations and/or multiples thereof. For example, the data storage media can include flash-based solid-state drives (SSDs), magnetic-based hard disk drives, magnetic tape, optical discs, and/or the like including combinations and/or multiples thereof.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, and/or the like including combinations and/or multiples thereof), data manipulation commands (e.g., browse, copy, paste, move, delete, create, compress, and/or the like including combinations and/or multiples thereof), data manipulation results, and/or the like including combinations and/or multiples thereof. In one or more examples, the computing system 102 can manipulate the data already stored/being stored in the data collection system 150 based on outputs from the one or more machine learning models (e.g., phase detection, anatomical structure detection, surgical tool detection, and/or the like including combinations and/or multiples thereof). Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

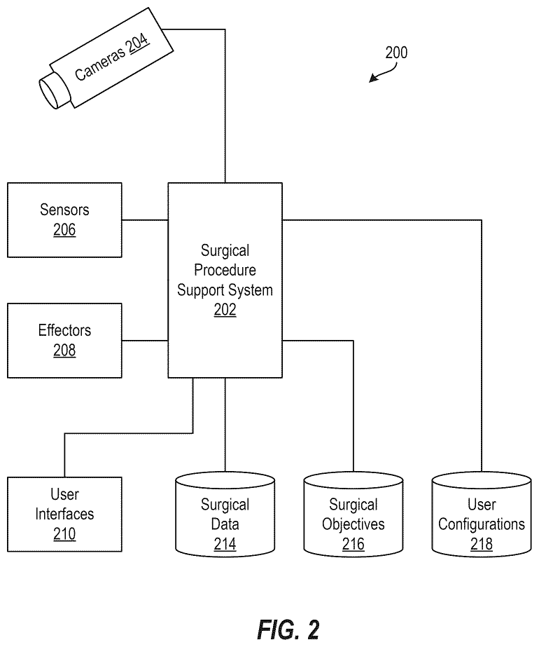

Turning now to FIG. 2, a surgical procedure system 200 is generally shown according to one or more aspects. The example of FIG. 2 depicts a surgical procedure support system 202 that can include or may be coupled to the CAS system 100 of FIG. 1. The surgical procedure support system 202 can acquire image or video data using one or more cameras 204. The surgical procedure support system 202 can also interface with one or more sensors 206 and/or one or more effectors 208. The sensors 206 may be associated with surgical support equipment and/or patient monitoring. The effectors 208 can be robotic components or other equipment controllable through the surgical procedure support system 202. The surgical procedure support system 202 can also interact with one or more user interfaces 210, such as various input and/or output devices. The surgical procedure support system 202 can store, access, and/or update surgical data 214 associated with a training dataset and/or live data as a surgical procedure is being performed on patient 110 of FIG. 1. The surgical procedure support system 202 can store, access, and/or update surgical objectives 216 to assist in training and guidance for one or more surgical procedures. User configurations 218 can track and store user preferences.

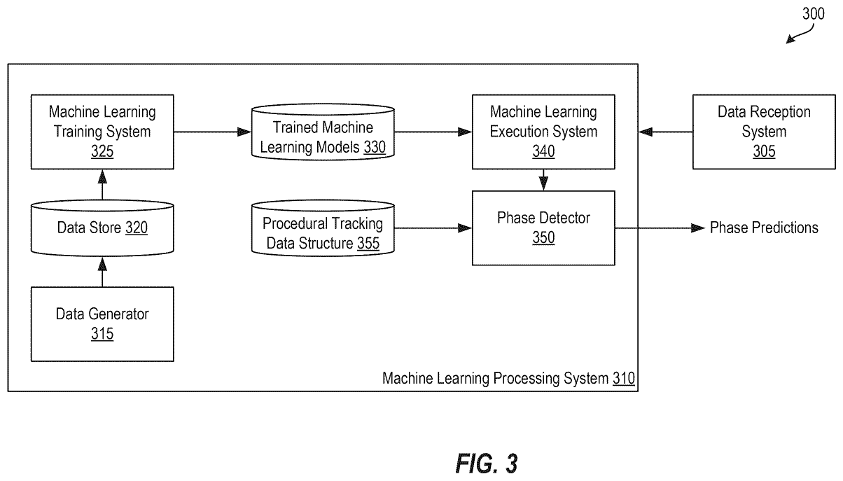

Turning now to FIG. 3, a system 300 for analyzing video and data is generally shown according to one or more aspects. In accordance with aspects, the video and data is captured from video recording system 104 of FIG. 1. The analysis can result in predicting features that include surgical phases and structures (e.g., instruments, anatomical structures, and/or the like including combinations and/or multiples thereof) in the video data using machine learning. System 300 can be the computing system 102 of FIG. 1, or a part thereof in one or more examples. System 300 uses data streams in the surgical data to identify procedural states according to some aspects.

System 300 includes a data reception system 305 that collects surgical data, including the video data and surgical instrumentation data. The data reception system 305 can include one or more devices (e.g., one or more user devices and/or servers) located within and/or associated with a surgical operating room and/or control center. The data reception system 305 can receive surgical data in real-time, i.e., as the surgical procedure is being performed. Alternatively, or in addition, the data reception system 305 can receive or access surgical data in an offline manner, for example, by accessing data that is stored in the data collection system 150 of FIG. 1.

System 300 further includes a machine learning processing system 310 that processes the surgical data using one or more machine learning models to identify one or more features, such as surgical phase, instrument, anatomical structure, and/or the like including combinations and/or multiples thereof, in the surgical data. It will be appreciated that machine learning processing system 310 can include one or more devices (e.g., one or more servers), each of which can be configured to include part or all of one or more of the depicted components of the machine learning processing system 310. In some instances, a part or all of the machine learning processing system 310 is cloud-based and/or remote from an operating room and/or physical location corresponding to a part or all of data reception system 305. It will be appreciated that several components of the machine learning processing system 310 are depicted and described herein. However, the components are just one example structure of the machine learning processing system 310, and that in other examples, the machine learning processing system 310 can be structured using a different combination of the components. Such variations in the combination of the components are encompassed by the technical solutions described herein.

The machine learning processing system 310 includes a machine learning training system 325, which can be a separate device (e.g., server) that stores its output as one or more trained machine learning models 330. The trained machine learning models 330 are accessible by a machine learning execution system 340. The machine learning execution system 340 can be separate from the machine learning training system 325 in some examples. In other words, in some aspects, devices that “train” the models are separate from devices that “infer,” i.e., perform real-time processing of surgical data using the trained machine learning models 330.

Machine learning processing system 310, in some examples, further includes a data generator 315 to generate simulated surgical data, such as a set of synthetic images and/or synthetic video, in combination with real image and video data from the video recording system 104, to generate trained machine learning models 330. Data generator 315 can access (read/write) a data store 320 to record data, including multiple images and/or multiple videos. The images and/or videos can include images and/or videos collected during one or more procedures (e.g., one or more surgical procedures). For example, the images and/or video may have been collected by a user device worn by the actor 112 of FIG. 1 (e.g., surgeon, surgical nurse, anesthesiologist, and/or the like including combinations and/or multiples thereof) during the surgery, a non-wearable imaging device located within an operating room, an endoscopic camera inserted inside the patient 110 of FIG. 1, and/or the like including combinations and/or multiples thereof. The data store 320 is separate from the data collection system 150 of FIG. 1 in some examples. In other examples, the data store 320 is part of the data collection system 150.

Each of the images and/or videos recorded in the data store 320 for performing training (e.g., generating the trained machine learning models 330) can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, and/or the like including combinations and/or multiples thereof). Further, the other data can include image-segmentation data that identifies and/or characterizes one or more objects (e.g., tools, anatomical objects, and/or the like including combinations and/or multiples thereof) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 325 uses the recorded data in the data store 320, which can include the simulated surgical data (e.g., set of synthetic images and/or synthetic video) and/or actual surgical data to generate the trained machine learning models 330. The trained machine learning models 330 can be defined based on a type of model and a set of hyperparameters (e.g., defined based on input from a client device). The trained machine learning models 330 can be configured based on a set of parameters that can be dynamically defined based on (e.g., continuous or repeated) training (i.e., learning, parameter tuning). Machine learning training system 325 can use one or more optimization algorithms to define the set of parameters to minimize or maximize one or more loss functions. The set of (learned) parameters can be stored as part of the trained machine learning models 330 using a specific data structure for a particular trained machine learning model of the trained machine learning models 330. The data structure can also include one or more non-learnable variables (e.g., hyperparameters and/or model definitions).

Machine learning execution system 340 can access the data structure(s) of the trained machine learning models 330 and accordingly configure the trained machine learning models 330 for inference (e.g., prediction, classification, and/or the like including combinations and/or multiples thereof). The trained machine learning models 330 can include, for example, a fully convolutional network adaptation, an adversarial network model, an encoder, a decoder, or other types of machine learning models. The type of the trained machine learning models 330 can be indicated in the corresponding data structures. The trained machine learning models 330 can be configured in accordance with one or more hyperparameters and the set of learned parameters.

The trained machine learning models 330, during execution, receive, as input, surgical data to be processed and subsequently generate one or more inferences according to the training. For example, the video data captured by the video recording system 104 of FIG. 1 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 305, which can include one or more devices located within an operating room where the surgical procedure is being performed. Alternatively, the data reception system 305 can include devices that are located remotely, to which the captured video data is streamed live during the performance of the surgical procedure. Alternatively, or in addition, the data reception system 305 accesses the data in an offline manner from the data collection system 150 or from any other data source (e.g., local or remote storage device).

The data reception system 305 can process the video and/or data received. The processing can include decoding when a video stream is received in an encoded format such that data for a sequence of images can be extracted and processed. The data reception system 305 can also process other types of data included in the input surgical data. For example, the surgical data can include additional data streams, such as audio data, RFID data, textual data, measurements from one or more surgical instruments/sensors, and/or the like including combinations and/or multiples thereof, that can represent stimuli/procedural states from the operating room. The data reception system 305 synchronizes the different inputs from the different devices/sensors before inputting them in the machine learning processing system 310.

The trained machine learning models 330, once trained, can analyze the input surgical data, and in one or more aspects, predict and/or characterize features (e.g., structures) included in the video data included with the surgical data. The video data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data or predicting the localization of the structures with a probabilistic heatmap. In some instances, the one or more trained machine learning models 330 include or are associated with a preprocessing or augmentation (e.g., intensity normalization, resizing, cropping, and/or the like including combinations and/or multiples thereof) that is performed prior to segmenting the video data. An output of the one or more trained machine learning models 330 can include image-segmentation or probabilistic heatmap data that indicates which (if any) of a defined set of structures are predicted within the video data, a location and/or position and/or pose of the structure(s) within the video data, and/or state of the structure(s). The location can be a set of coordinates in an image/frame in the video data. For example, the coordinates can provide a bounding box. The coordinates can provide boundaries that surround the structure(s) being predicted. The trained machine learning models 330, in one or more examples, are trained to perform higher-level predictions and tracking, such as predicting a phase of a surgical procedure and tracking one or more surgical instruments used in the surgical procedure.

While some techniques for predicting a surgical phase (“phase”) in the surgical procedure are described herein, it should be understood that any other technique for phase prediction can be used without affecting the aspects of the technical solutions described herein. In some examples, the machine learning processing system 310 includes a detector 350 that uses the trained machine learning models 330 to identify various items or states within the surgical procedure (“procedure”). The detector 350 can use a particular procedural tracking data structure 355 from a list of procedural tracking data structures. The detector 350 can select the procedural tracking data structure 355 based on the type of surgical procedure that is being performed. In one or more examples, the type of surgical procedure can be predetermined or input by actor 112. For instance, the procedural tracking data structure 355 can identify a set of potential phases that can correspond to a part of the specific type of procedure as “phase predictions”, where the detector 350 is a phase detector.

In some examples, the procedural tracking data structure 355 can be a graph that includes a set of nodes and a set of edges, with each node corresponding to a potential phase. The edges can provide directional connections between nodes that indicate (via the direction) an expected order during which the phases will be encountered throughout an iteration of the procedure. The procedural tracking data structure 355 may include one or more branching nodes that feed to multiple next nodes and/or can include one or more points of divergence and/or convergence between the nodes. In some instances, a phase indicates a procedural action (e.g., surgical action) that is being performed or has been performed and/or indicates a combination of actions that have been performed. In some instances, a phase relates to a biological state of a patient undergoing a surgical procedure. For example, the biological state can indicate a complication (e.g., blood clots, clogged arteries/veins, and/or the like including combinations and/or multiples thereof), pre-condition (e.g., lesions, polyps, and/or the like including combinations and/or multiples thereof). In some examples, the trained machine learning models 330 are trained to detect an “abnormal condition,” such as hemorrhaging, arrhythmias, blood vessel abnormality, and/or the like including combinations and/or multiples thereof.

Each node within the procedural tracking data structure 355 can identify one or more characteristics of the phase corresponding to that node. The characteristics can include visual characteristics. In some instances, the node identifies one or more tools that are typically in use or available for use (e.g., on a tool tray) during the phase. The node also identifies one or more roles of people who are typically performing a surgical task, a typical type of movement (e.g., of a hand or tool), and/or the like including combinations and/or multiples thereof. Thus, detector 350 can use the segmented data generated by machine learning execution system 340 that indicates the presence and/or characteristics of particular objects within a field of view to identify an estimated node to which the real image data corresponds. Identification of the node (i.e., phase) can further be based upon previously detected phases for a given procedural iteration and/or other detected input (e.g., verbal audio data that includes person-to-person requests or comments, explicit identifications of a current or past phase, information requests, and/or the like including combinations and/or multiples thereof).

The detector 350 can output predictions, such as a phase prediction associated with a portion of the video data that is analyzed by the machine learning processing system 310. The phase prediction is associated with the portion of the video data by identifying a start time and an end time of the portion of the video that is analyzed by the machine learning execution system 340. The phase prediction that is output can include segments of the video where each segment corresponds to and includes an identity of a surgical phase as detected by the detector 350 based on the output of the machine learning execution system 340. Further, the phase prediction, in one or more examples, can include additional data dimensions, such as, but not limited to, identities of the structures (e.g., instrument, anatomy, and/or the like including combinations and/or multiples thereof) that are identified by the machine learning execution system 340 in the portion of the video that is analyzed. The phase prediction can also include a confidence score of the prediction. Other examples can include various other types of information in the phase prediction that is output. Further, other types of outputs of the detector 350 can include state information or other information used to generate audio output, visual output, and/or commands. For instance, the output can trigger an alert, an augmented visualization, identify a predicted current condition, identify a predicted future condition, command control of equipment, and/or result in other such data/commands being transmitted to a support system component, e.g., through surgical procedure support system 202 of FIG. 2.

It should be noted that although some of the drawings depict endoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room (e.g., surgeon). Alternatively, or in addition, the cameras can be mounted on surgical instruments, walls, or other locations in the operating room. Alternatively, or in addition, the video can be images captured by other imaging modalities, such as ultrasound.

As described regarding FIGS. 1-3, it is often desirable to perform computer vision applications during or after surgical procedures, such as to perform surgical phase annotation, surgical instrument detection and tracking, anatomy localization and segmentation, and/or the like, including combinations and/or multiples thereof. For example, one or more aspects provides a vision backbone for generating spatial-temporal features to power online and offline models for computer vision applications. One or more aspects described herein provide a low latency approach for processing a sequence of frames of a video and generating robust spatial-temporal features. One or more aspects described herein provide adaptive control of computational resources to run more models on relatively low powered processing systems. For example, FLOPs of the STMN model can be dynamically adapted to run more models in parallel on a relatively low powered processing system. According to one or more aspects, processing needs can be adjusted for post-operative video models to speed up inference and reduce processing resource costs, such as the computing costs of using graphical processing unit for performing post-operative video analytics. These and other aspects are now described in more detail.

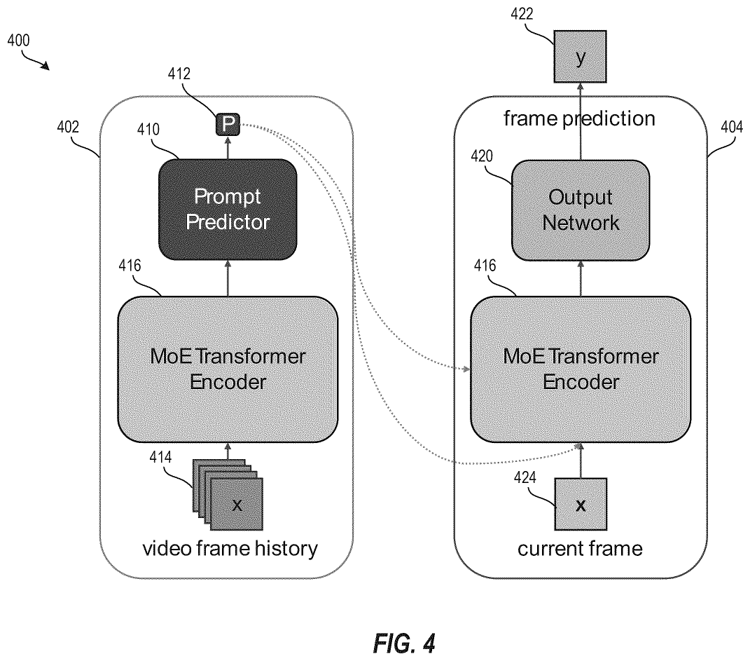

One or more aspects described herein provide a spatial-temporal modular network. For example, FIG. 4 depicts a STMN model 400 according to one or more aspects. The STMN model 400 provides for generating temporal features for a given video-processing task (e.g., surgical phase annotation, surgical instrument detection and tracking, anatomy localization and segmentation). The STMN model 400 includes a prompting stage 402 and a prediction stage 404. The STMN model 400 uses a light-weight prompt predictor in the prompting stage 402 to generate temporal features (e.g., temporal prompts P 412) from a history of video frames (e.g., video frame history 414). The main backbone of the STMN model 400 is a MoE transformer encoder 416 that uses mixture of experts as is further described herein. When processing a current frame 424 during the prediction stage 404, the temporal prompts P 412 are exploited to help select which parts of the STMN model 400 to activate using MoE attention-routing to generate better features for downstream computer vision application tasks.

The prompting stage 402 generates temporal prompts P 412 using a light-weight prompt predictor 410. More particularly, previous video frame history 414 is processed by a MoE transformer encoder 416 to generate a set of image features, which are then processed by the prompt predictor 410 (e.g., a small transformer architecture) to generate the temporal prompts P 412. According to one or more aspects, the prompt predictor 410 outputs the temporal prompts P 412 as a vector of temporal prompts that parameterize frame history and contain informative temporal context.

The prediction stage 404 provides for generating a prediction 422 (also referred to as a “frame prediction”) for a current frame 424 using the MoE transformer encoder 416 and an output network 420. The MoE transformer encoder 416 processes the current frame 424 and the temporal prompts P 412 from the prompting stage 402 using concatenation [x, P]. MoE layers (described in more detail herein) in the MoE transformer encoder 416 use the temporal prompts P 412 to determine the routing of patches of the current frame 424.

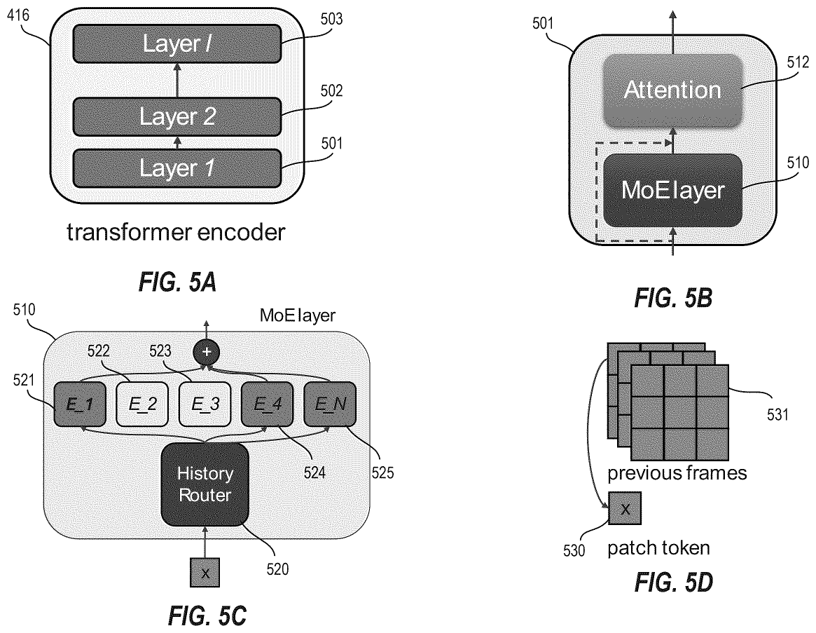

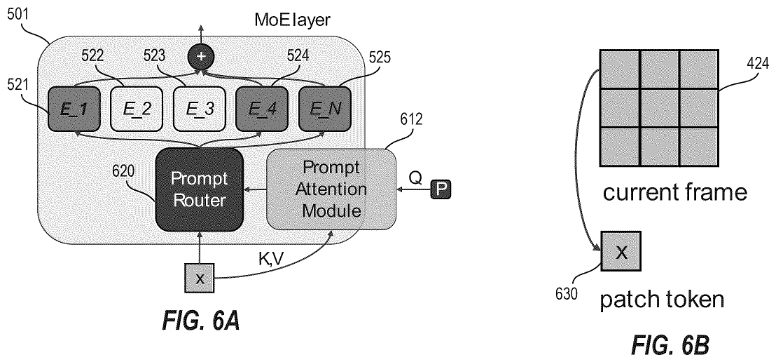

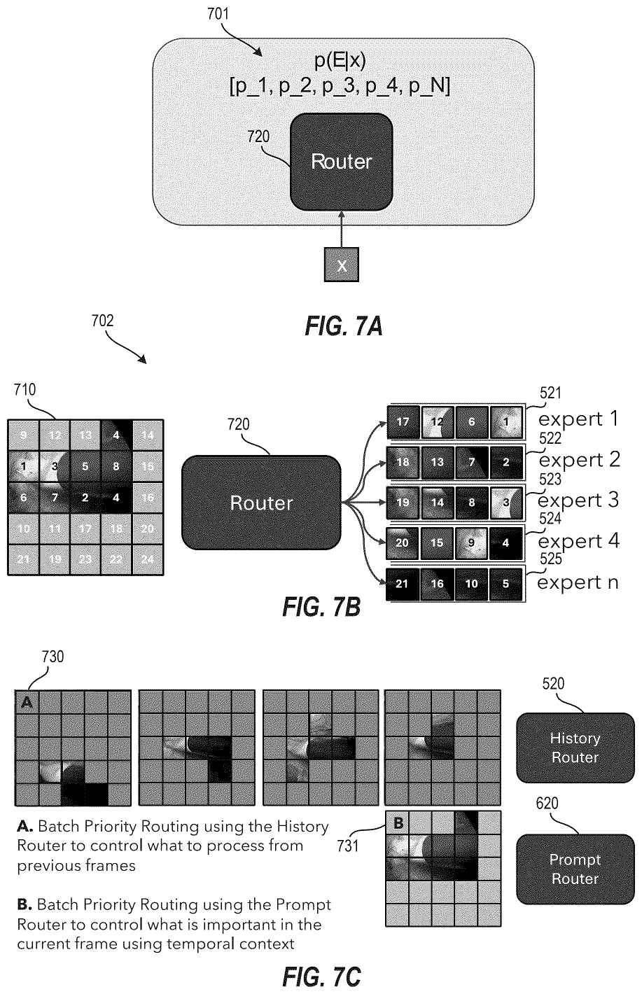

Architectural and functional features of the STMN model 400 are now described in more detail with reference to FIGS. 5A-7C but are not so limited. In particular, FIGS. 5A-5D depict MoE history routing for the STMN model 400 according to one or more aspects. FIGS. 6A and 6B depict aspects of MoE prompt routing for the STMN model 400 according to one or more aspects. FIGS. 7A-7C depict aspects of adaptive control with batch priority routing for the STMN model 400 according to one or more aspects.

With reference to FIGS. 5A-5D, MoE history routing is now described. The MoE transformer encoder 416 includes l layers, such as layer 1 501, layer 2 502, . . . layer l 503 as shown in FIG. 5A. Each of the l layers (e.g., the layers 501-503) includes an MoE layer 501 with residual connection and a multi-headed self-attention layer (e.g., attention layer 512) with residual connection as shown in FIG. 5B. Image patches are processed at each of the layers 501-503 of the MoE transformer encoder 416. Although the MoE layer 501 is shown in more detail in FIGS. 5B and 5C (as well as FIG. 6A), it should be appreciated that any of the l layers (e.g., the layers 501-503) can be similarly configured.

The MoE layer 501 includes N expert neural networks (e.g., networks 521, 522, 523, 524, 525) and a router, which may be a history router 520 or a prompt router 620 shown in FIG. 6A). The router (e.g., the history router 520) determines which of the networks 521-525 should be activated for a patch token x, which is a region of an image defined by a patch mapped to a feature vector, called a token. According to one or more embodiments, each patch token x from an image is fed into a router (e.g., the history router 520 and/or the prompt router 620), and each patch token x is routed differently according to the router output. The token is fed by the history router 520 to the activated expert neural networks (e.g., the networks 521, 524, 525 of FIG. 5C), and the output of the MoE layer 501 is a weighted sum of the outputs from the expert neural networks that are activated. According to one or more aspects, all patches in an image are routed to different sets of expert neural networks. The history router 520 performs routing based on frame history. According to one or more aspects, a 1-layer multi-layer perceptron network outputs Softmax probabilities of expert activation and uses a noisy top-k router mechanism. FIG. 5D shows a patch token 530, which is the input to the history router 520 and is based on previous frames 531 of the video frame history 414.

With reference to FIGS. 6A and 6B, MoE prompt routing is now described. As shown in FIG. 6A, the MoE layer 501 of the MoE transformer encoder 416 includes the networks 521-525, a prompt router 620, and a prompt attention module 612. FIG. 6B shows a patch token 630, which is the input to the prompt router 620 and is based on current frame 424.

In MoE prompt routing, expert weights (e.g., weights of the expert neural networks) are shared across the prompting stage 402 and the prediction stage 404, and only the routing of experts differs. The expert neural networks (e.g., the networks 521-525) are trained end-to-end such that the history router 520 learns to route for better temporal prompts P 412 while the prompt router 620 learns to route based on the temporal prompts P 412.

The prompt router 620 determines which of the networks 521-525 should be activate for the patch token x based on both x and the temporal prompts P 412. The token x is fed to each of the activated expert neural networks (e.g. the networks 521, 524, 525 in the example of FIG. 6A), and the output of the MoE layer 501 is a weighted sum of the outputs from the expert neural networks that are activated.

As shown in FIG. 6A, the prompt router 620 is a prompt conditioned router in that the prompt router 620 takes as input the patch token and performs attention over the temporal prompts P 412. Prior history guides activation of the expert neural networks for a given range according to one or more aspects. The prompt router 620 learns expert activation based on prior history for maximizing task performance according to one or more aspects.

Turning now to FIGS. 7A-7C, adaptive control at run-time is now described in more detail. The output of a router 720 (e.g., the history router 520 and/or the prompt router 620) provides for ranking each image patch based on importance. According to one or more embodiments, the ranking can be performed for patch tokens at all layers of the encoder. For example, at layer 1 501, patch tokens that correspond to the image location are dropped. Consider an image with a 3×3 grid; there are nine patches corresponding to a location in that 3×3 grid. However, at layer 1 503, patch tokens that do not correspond exactly to a region in the image but are more abstract feature representations that correspond to different spatial regions in feature space are dropped. As shown in FIG. 7A, the history router 520 and the prompt router 620 output probabilities 701 of expert activation for each token/patch in an image. The probabilities 701 can be used to sort patches and can be fed into a temporal-based batch priority routing algorithm of a batch priority routing approach 702.

More particularly, the batch priority routing approach 702, as shown in FIG. 7B, can be used to: control how much information to process in a history of video frames (e.g., the video frame history 141), and control how much information to process in a current frame (e.g., the current frame 424) given the temporal prompts (e.g., the temporal prompts P 412) from a history of frames (e.g., the video frame history 414). This is performed at run-time post-training by setting an expert capacity parameter, which determines how many image patches each expert can process. The expert capacity parameter can be tuned through cross-validation or dynamically changed during deployment according to one or more aspects.

For the batch priority routing approach 702, the expert neural networks (e.g., the networks 521-525) are assigned a capacity factor c. When c=1, all tokens (regions) within an image are processed by at least one expert. As c decreases and approaches “0”, the expert neural networks have limited capacity and can only process a small number of patches. For example, only the most informative regions are processed. The temporal-based batch priority routing algorithm of the batch priority routing approach 702 sorts patches 710 based on the probability of expert activation and iteratively fills experts until capacity is reached as shown in FIG. 7B. For example, the network 521 (e.g., “expert 1”) is assigned patches 17, 12, 6, and 1 of the patches 710; the network 522 (e.g., “expert 2”) is assigned patches 18, 13, 7, and 2; the network 523 (e.g., “expert 3”) is assigned patches 19, 14, 8, and 3; he network 524 (e.g., “expert 4”) is assigned patches 20, 15, 9, and 4; and the network 525 (e.g., “expert 5”) is assigned patches 21, 16, 10, and 5.

The capacity factor c is a parameter that can be tuned or adjusted at run-time according to one or more aspects. The capacity factor c can be expressed as a control capacity of the expert neural networks when processing a history of frames, namely c_{history}. The capacity factor c can additionally or alternatively be expressed as a control capacity of the exert neural networks for the current frame, namely (c_{prediction}). In either case, the STMN model 400 allows either or both of c_{history} and c_{prediction} to be varied.

In FIG. 7C, the number of patches routed to the expert neural networks can be reduced to use fewer computational resources (e.g., FLOPs). For example, at block 730, batch priority routing using the history router 520 to control what to process from previous frames. As another example, at block 731, batch priority routing uses the prompt router 620 to control what is important in the current frame using temporal context.

The STMN model 400 has many different applications and use cases. For example, the STMN model 400 provides a low-latency approach for processing generic temporal features for video based analysis. The STMN model 400 is agnostic to the task being performed and can power models for instrument and pose detection of surgical instruments, anatomy localization, surgical phase detection, and/or the like, including combinations and/or multiples thereof. The STMN model 400 produces robust features for either online or offline surgical video processing due to the history router 520 and the prompt router 620. The STMN model 400 provides a light-weight model for processing a window of frame. Compared to a model using temporal convolutions in a decoder (e.g., Swin-TCN) model, the prompt predictor 410 and the prompt router 620 are far less memory and computationally intensive.

As another example, the STMN enables increased parallel computing bandwidth on relatively low powered processing systems. For example, the bandwidth for parallel computing on relatively low powered processing systems can be increased by deploying models with different capacity factors c. Due to GPU constraints, only a relatively small number of models (e.g., 3 models) can be deployed and run simultaneously. By tuning the capacity factor c of the STMN models before deployment, the memory needed for each model can be adjusted. As a result, more models (e.g, 5 models) can be deployed and run simultaneously due to relaxing the memory requirements for each model.

As yet another example, the STMN model 400 provides for dynamically adjusting GPU memory at run-time on relatively low powered processing systems so that such processing systems can run additional models. For example, memory requirements of models can be dynamically adjusted for deploying the STMN models on relatively low powered processing systems. In a situation where multiple models are deployed on a relatively low powered processing system, it may not be possible to run all the STMN models in parallel due to limited availability of processing system resources (e.g., limited memory resources). To address this problem, aspects described herein provide for dynamically adjusting processing system resources of a first model that is running when a second model needs to run by adjusting the capacity factor c of the first model to free up resources for the second model. When the second model no longer needs to run, the resources for the first model can be readjusted by adjusting the capacity factor c of the first model.

As yet another example, the STMN model 400 provides faster offline processing for post-operative analysis. Memory requirements and processing speed of the STMN model can be tuned by varying the capacity factor c. When applied to post-operative surgical videos, this can reduce the computational power and GPU time necessary to process vides and reduce GPU costs due to less time needed to process videos.

According to one or more aspects, the STMN model 400 provides for multi-task prompt learning, which addresses issues with simultaneously running different models on relatively low powered processing systems. For example, the size of the GPU of relatively low powered processing systems often prohibits running more than a few (e.g., more than two or three) models in parallel. The STMN model 400 can be adapted towards a multi-task learning model by generating multi-task temporal prompts. This approach provides benefits including running a single model with a light-weight module for generating multi-task temporal prompts for efficient deployment on relatively low powered processing systems. Further, by using the MoE transformer encoder 416 adapted for multi-task learning, adaptive controls of run-time FLOPs across tasks are provided, thus giving fine-grained control on computing resources.

According to one or more aspects, the STMN model 400 provides for temporal weighting on previous frames. For example, when processing a video, frames that are closer in time may have more informative features than a frame that was processed a long time ago. As a result, the model can understand time to better learn how to drop unnecessary regions in a history of frames to speed up processing.

According to one or more aspects, the STMN model 400 provides for multi-task prompt learning. In multi-task learning, a single model generates outputs for multiple tasks. This can save significant GPU memory since we only need a single model to generate multiple outputs compared to the current paradigm where we need separate models. For multi-task prompt learning, the prompt predictor 410 takes as input task-specific representations from the MoE transformer encoder 416. From a sequence of frames, the prompt predictor 410 outputs prompts that model task-specific temporal context. This provides for efficient low-latency cross-task temporal communication for tractable deployment on relatively low powered processing systems. In the case of multi-task prompt learning, the MoE layers (e.g., the MoE layers 501-503) can be adapted to learn which expert neural networks are shared across tasks. This approach provides similar benefits to single-task models while significantly increasing the number of models that can run in parallel on relatively low powered processing systems. Moreover, this approach provides fine-grained control on computational resources pre task to speed up inference.

According to one or more aspects, the STMN model 400 can be extended to provide temporal weighting on previous frames. To this, an exponential function is placed on the importance of patches/tokens from frames further in the past. When applying the batch priority routing approach 702 described herein over a history of frames, more patches from more recent frames are processed as compared to less recent frames. According to one or more aspects, positional embeddings can be used to learn a function in the history router 520, which understands the relationship between feature importance and time dependency in the temporal-based batch priority routing algorithm of the batch priority routing approach 702.

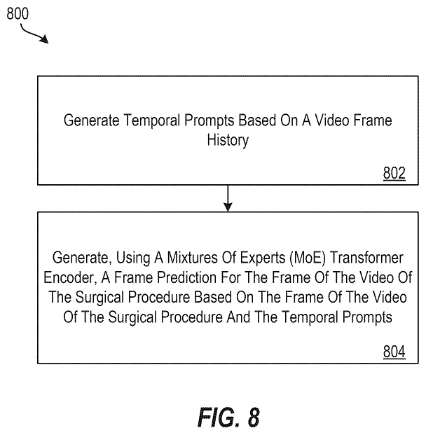

Turning now to FIG. 8, a flow diagram of a method 800 for generating a frame prediction (e.g., spatial-temporal features for video processing applications) for a frame of a video of a surgical procedure is provided according to one or more aspects described herein. The method 800 can be performed by any suitable system or device, such as the computing system 102 of FIG. 1, the surgical procedure support system 202 of FIG. 2, the machine learning processing system 310 of FIG. 3, and/or the processing system 900 of FIG. 9. According to one or more aspects, the method 800 is implemented by the machine learning execution system 340. FIG. 8 is now described in more detail with reference to FIGS. 5 and 6 but is not so limited.

At block 802, the machine learning execution system 340 generates temporal prompts (e.g., the temporal prompts P 412) based on a video frame history (e.g., the video frame history 414). At block 804, the machine learning execution system 340 generates a MoE transformer encoder (e.g., the MoE transformer encoder 416), a frame prediction (e.g., the frame prediction 422) for a frame (e.g., the current frame 424) of a video of a surgical procedure based on the frame (e.g., the current frame 424) of the video of the surgical procedure and the temporal prompts (e.g., the temporal prompts P 412).

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., one or more of the processors 921 of FIG. 9) of a computing system (e.g., the processing system 900 of FIG. 9), cause the processor to perform the processes described herein.

Results of implementing the STMN model 400 and/or the method 800 are now described. According to an aspect, the STMN model 400 was trained, validated, and tested on videos of laparoscopic cholecystectomy surgical procedures. As baselines, the following were considered: a sliding window (Swin) transformer model and a spatial-temporal prompting network (STPN). Two sets of results for the STMN model 400 are provided where TopK=1 and where TopK=6. For TopK=1, each token activates only one expert neural network, which keeps the inference speed constant with respect to Swin Tiny baseline. For TopK=6, each token activates up to six expert neural networks. In this case, the inference speed is slower but is mitigated through the temporal-based batch priority routing approach (e.g., the batch priority routing approach 702). The STMN model 400 significantly outperforms the two baselines. For example, the STMN outperforms the Swin transformer model by substantially 2.9% and 5.0% and outperforms the STPN by substantially 2.0% and substantially 2.7% in mean dice artery and mean dice duct respectively, as shown in Table 1.

| Model | Mean Dice Artery | Mean Dice Duct |
|---|---|---|
| Swin Tiny | 0.512 | 0.618 |
| STPN (window = 5) | 0.517 (+0.9%) | 0.632 (+2.3%) |
| STMN (window = 5, | 0.519 (+1.4%) | 0.645(+4.4%) |
| experts = 6, top-k = 1) | | |
| STMN (window = 5, | 0.527 (+2.9%) | 0.649 (+5.0%) |
| experts = 15, top-k = 6) | | |

Tradeoffs in performance when controlling expert capacity of the temporal based batch priority routing algorithm are now discussed, particularly the effect on two different downstream tasks: organ presence (classification) and organ localization (segmentation). The expert capacity across the temporal batch was decreased starting from 100% (no dropping of tokens) to 50% (up to 50% of tokens across the frame history and the current frame are dropped). Results in Table 2 show that there are a significant number of tokes than can be dropped with only marginal effects on performance. For example, an n % drop in tokes correlates to an n % reduction in FLOPs.

| | F1 Duct | F1 Artery | Dice Duct | Dice Artery |
|---|---|---|---|---|
| 100% | 0.820 | 0.785 | 0.689 | 0.579 |
| 90% | 0.817 | 0.778 | 0.687 | 0.579 |
| 80% | 0.808 | 0.774 | 0.675 | 0.573 |
| 70% | 0.783 | 0.739 | 0.655 | 0.574 |
| 60% | 0.726 | 0.682 | 0.621 | 0.561 |
| 50% | 0.642 | 0.602 | 0.552 | 0.514 |

It is understood that one or more aspects described herein is capable of being implemented in conjunction with any other type of computing environment now known or later developed. For example, FIG. 9 depicts a block diagram of a processing system 900 for implementing the techniques described herein. In accordance with one or more aspects described herein, the processing system 900 is an example of a cloud computing node of a cloud computing environment. In examples, processing system 900 has one or more central processing units (referred to also as “processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to a system memory 922 and/or various other components via a system bus 933. The system memory 922 can include one or more temporary and/or persistent memory devices, such as a random access memory (RAM) 923, a read-only memory (ROM) 924, and/or the like, including combinations and/or multiples thereof. The system bus 933 may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 935 and/or a storage device 936 or any other similar component. I/O adapter 927, hard disk 935, and storage device 936 are collectively referred to herein as mass storage 934. Operating system 940 for execution on processing system 900 may be stored in mass storage 934. The network adapter 926 interconnects system bus 933 with an outside network 938 enabling processing system 900 to communicate with other such systems.

A display (e.g., a display monitor) 939 is connected to system bus 933 by display adapter 932, which may include a graphics adapter to improve the performance of graphics intensive applications and a video controller. In one aspect of the present disclosure, adapters 926, 927, and/or 932 may be connected to one or more I/O buses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a GPU 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including the system memory 922 and mass storage 934, input means such as keyboard 929 and mouse 930, and output capability including speaker 931 and display 939. In some aspects of the present disclosure, a portion of system memory 922 and mass storage 934 collectively store the operating system 940 to coordinate the functions of the various components shown in processing system 900.

Aspects described herein may be a system, a method, and/or a computer program product at any possible technical detail level of integration. The computer program product may include a computer-readable storage medium (or media) having computer-readable program instructions thereon for causing a processor to carry out aspects described herein.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations described herein may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, high-level languages such as Python, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects described herein.

Aspects are described herein with reference to flowchart illustrations and/or block diagrams of methods, apparatus (systems), and computer program products according to aspects described herein. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects described herein have been presented for purposes of illustration but are not intended to be exhaustive or limited to the aspects disclosed. Many modifications and variations will be apparent to those of ordinary skill in the art without departing from the scope of the described aspects. The terminology used herein was chosen to best explain the principles of the aspects, the practical application or technical improvement over technologies found in the marketplace, or to enable others of ordinary skill in the art to understand the aspects described herein.

Various aspects are described herein with reference to the related drawings. Alternative aspects can be devised without departing from the scope of the aspects described herein. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of +8% or 5%, or 2% of a given value.

For the sake of brevity, conventional techniques related to making and using the aspects described herein may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general-purpose microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A computer-implemented method for generating a frame prediction for a frame of a video of a surgical procedure, the method comprising:
generating temporal prompts based on a video frame history; and
generating, using a mixture of experts (MoE) transformer encoder, the frame prediction for the frame of the video of the surgical procedure based on the frame of the video of the surgical procedure and the temporal prompts.

2. The computer-implemented method of claim 1, wherein generating the temporal prompts is performed by a prompt predictor network.

3. The computer-implemented method of claim 2, wherein the prompt predictor network is a small transformer architecture.

4. The computer-implemented method of claim 1, wherein the temporal prompts are expressed as a vector of temporal prompts that parameterize the video frame history and contain informative temporal context.

5. The computer-implemented method of claim 1, wherein the MoE transformer encoder processes the frame of the video of the surgical procedure and the temporal prompts using concatenation.

6. The computer-implemented method of claim 1, wherein the MoE transformer encoder comprises a plurality of layers.

7. The computer-implemented method of claim 6, wherein the plurality of layers of the MoE transformer encoder use the temporal prompts to determine routing of patches of the frame of the video of the surgical procedure.

8. The computer-implemented method of claim 6, wherein each of the plurality of layers of the MoE transformer encoder comprises a MoE layer with residual connection and a multi-headed self-attention layer with residual connection.

9. The computer-implemented method of claim 8, wherein the MoE layer of each of the plurality of layers of the MoE transformer encoder comprises a router and a plurality of expert neural networks, wherein the router decides which of the plurality of expert neural networks to activate for processing a patch token associated with the frame of the video of the surgical procedure.

10. The computer-implemented method of claim 9, wherein the router is a history router, the history router deciding which expert neural networks to activate based on the patch token.

11. The computer-implemented method of claim 9, wherein the router is a prompt router, the prompt router deciding which expert neural networks to activate based on the patch token and the temporal prompts.

12. The computer-implemented method of claim 9, wherein the patch token is fed into each of the plurality of expert neural networks that are activated, and wherein an output the MoE layer is a weighted sum of outputs of each of the expert neural networks that are activated.

13. A system comprising:
a data store comprising video data comprising a sequence of a plurality of image frames associated with a surgical procedure; and
a machine learning execution system comprising a spatial-temporal modular network (STMN) model comprising a prompt predictor network and a mixture of experts (MoE) transformer encoder, the STMN model configured to:
generate, using the prompt predictor network, temporal prompts based on a video frame history; and
generate, using the MoE transformer encoder, a frame prediction for one of the plurality of image frames of the video data of the surgical procedure based on one of the plurality of image frames and the temporal prompts.

14. The system of claim 13, wherein the temporal prompts are expressed as a vector of temporal prompts that parameterize the video frame history and contain informative temporal context.

15. The system of claim 13, wherein the MoE transformer encoder processes the one of the plurality of image frames and the temporal prompts using concatenation.

16. The system of claim 13, wherein the MoE transformer encoder comprises a plurality of layers, wherein the plurality of layers of the MoE transformer encoder use the temporal prompts to determine routing of patches of the one of the plurality of image frames, wherein each of the plurality of layers of the MoE transformer encoder comprises a MoE layer with residual connection and a multi-headed self-attention layer with residual connection.

17. The system of claim 16, wherein the MoE layer of each of the plurality of layers of the MoE transformer encoder comprises a router and a plurality of expert neural networks, wherein the router decides which of the plurality of expert neural networks to activate for processing a patch token associated with the one of the plurality of image frames.

18. The system of claim 17, wherein the router is a history router, the history router deciding which expert neural networks to activate based on the patch token.

19. The system of claim 17, wherein the router is a prompt router, the prompt router deciding which expert neural networks to activate based on the patch token and the temporal prompts.

20. A computer program product comprising:
a set of one or more computer-readable storage media; and
program instructions, collectively stored in the set of one or more storage media, for causing a processor set to perform operations for generating a frame prediction for a frame of a video of a surgical procedure, the operations comprising:
generating temporal prompts based on a video frame history, the temporal prompts expressed as a vector of temporal prompts that parameterize the video frame history and contain informative temporal context; and
generating, using a mixture of experts (MoE) transformer encoder, the frame prediction for the frame of the video of the surgical procedure based on the frame of the video of the surgical procedure and the temporal prompts, wherein generating the frame prediction further comprises processing the frame of the video of the surgical procedure and the temporal prompts using concatenation.
